(19) United States
(12) Patent Application Publication
(10) Pub. No.: US 2013/0230445 A1
(43) Pub. Date: Sep. 5, 2013

(54) Method Of Processing Wafer Waste

(71) Applicants: Tung-Ko Cheng, New Taipei City (TW); Li-Yin Hsiao, Tainan City (TW)

(72) Inventors: Tung-Ko Cheng, New Taipei City (TW); Li-Yin Hsiao, Tainan City (TW)

(73) Assignee: Hong Tung Resource Co., Ltd., Taoyuan County (TW)

(21) Appl. No.: 13/612,998

(22) Filed: Sep. 13, 2012

(30) Foreign Application Priority Data
Mar. 3, 2012 (TW) 101107155

(51) Int. Cl. C01B 33/02; C01B 31/36

(52) U.S. Cl. 423/345; 423/348

(57) ABSTRACT

Provided is a method of processing wafer waste. First, the wafer waste is separated into liquid mixture and solid mixture by solid-liquid separation. Next, a recovered cutting fluid is isolated from the liquid mixture by evaporation. The solid mixture is mixed with a first aqueous solvent to obtain a mixing slurry. Then, the mixing slurry is separated into a silicon-containing mixture and a silicon carbide-containing mixture. After suitable washing process, a recovered silicon and a recovered silicon carbide are finally obtained. Thus, the method recovers the cutting fluid, silicon and silicon carbide in the same process, which can reduce the environmental contaminations caused by wafer waste and reduce the manufacture cost of wafer production by recovering the wafer waste.

### RELATED APPLICATION

The present invention claims the priority of Taiwan Patent Application No. 101107155 filed on Mar. 3, 2012, which is incorporated by reference in the present application in its entirety.

### BACKGROUND OF THE INVENTION

1. Field of the Invention

The present invention relates to a method of processing wafer waste, and more particularly to a method of recovering reusable cutting fluid, silicon, and silicon carbide from the wafer waste in the same process.

2. Description of the Prior Arts

Silicon is a base material usually used in the integral circuit field or photovoltaic field. Generally, a grown silicon ingot undergoes the following processes such as cutting (slicing), edge contouring, lapping, grinding, polishing, chemical etching, and cleaning. After that, a desired wafer is obtained and can be used in various semiconductor fields.

A grown silicon ingot is cut into multiple wafers with same thickness by using wire saws. During the cutting process, abrasive particles contained in the wafer cutting slurry are moved between the silicon ingot and the wire saw to cut the silicon ingot. Typically, the wafer cutting slurry is composed of cutting fluid and silicon carbide (SiC) as abrasive particles. The cutting fluid is composed of medium (e g mineral oils or synthetic oils) having desired viscosity, such as polyalkylene glycol (PAG), polyethylene glycol (PEG), diethylene glycol (DEG) or propylene glycol (PG).

In the wafer cutting process, about 50% of silicon material becomes filings and are mixed in the wafer cutting slurry. Granular silicon carbide (abrasive particles) is cracked due to mechanical stress and thermal effect, and thereby reducing the cutting efficiency and degrading the quality of wafer by using the cracked abrasive particles. In order to overcome the afore-mentioned problems, conventional method needs to discard large amount of wafer cutting slurry and replace it by new wafer cutting slurry to maintain the cutting efficiency and lapping efficiency of silicon carbide. However, a large amount of wafer waste and serious environmental contaminations will be produced by this way.

Thus, in order to overcome the drawbacks of the afore-mentioned prior art, how to collect all reusable components such as cutting fluid, silicon, and silicon carbide is an urgent goal in the recovering field.

As disclosed by the publication of CN 101130237A, a method of processing wafer waste is provided. The binding agents and suspending agents contained in the wafer waste are removed by an organic solvent. Then, an obtained solid mixture is processed by gas flotation to recover silicon and silicon carbide.

As disclosed by the patent of TW 1347305, wafer waste is washed with acetone and is processed by centrifugal separation to remove the oil contaminants Then, a suitable acidic washing process is performed to remove metal components in the wafer waste. At last, purification at high temperature is performed to recover silicon and silicon carbide. However, this method consumes too much energy and is not suitable for recovering large amount of wafer waste.

As disclosed by the patent of TW M403370, an apparatus for recovering used oil from wafer waste is provided. The apparatus needs to perform an additional refining process to isolate the used oil. However, the component of isolated used oil is changed during the refining process, resulting in that the isolated used oil cannot be reused in the wafer cutting process.

Therefore, there is no applicable method to recover reusable cutting fluid, silicon, and silicon carbide from the wafer waste in the same process before the present invention is made.

### SUMMARY OF THE INVENTION

To overcome the shortcomings and predicament of the conventional techniques, the primary object of the present invention is to provide a method of recovering reusable cutting fluid, silicon, and silicon carbide from the wafer waste in the same process. Because the recovered cutting fluid, silicon, and silicon carbide can be reused in a variety of applications, the environmental contaminations caused by wafer waste will be reduced.

In order to achieve the afore-mentioned object, the present invention provides a method of processing wafer waste, comprising the steps of: (A) diluting a wafer waste to obtain a diluted wafer waste, wherein the wafer waste includes silicon, silicon carbide and a cutting fluid; (B) separating the diluted wafer waste into a liquid mixture and a solid mixture by solid-liquid separation, and separating the liquid mixture to obtain a first recycling water and a recovered cutting fluid; (C) mixing an amount of a first aqueous solvent with the solid mixture to obtain a mixing slurry; (D) separating the mixing slurry into a silicon-containing mixture and a silicon carbide-containing mixture by using a hydrocyclone; and (E) washing the silicon-containing mixture with an acidic solution to obtain a recovered silicon from the washed silicon-containing mixture, and washing the silicon carbide-containing mixture with a basic solution and the acidic solution in sequence to obtain a recovered silicon carbide from the washed silicon carbide-containing mixture.

In order to avoid reducing the separation efficiency of mixing slurry due to the presence of cutting fluid, the cutting fluid of wafer waste needs to be isolated and collected from the diluted wafer waste before separating the mixing slurry by using the hydrocyclone. By this way, the total and individual recovery rates of the cutting fluid, silicon, and silicon carbide from the wafer waste will be increased.

According to the present invention, said “wafer waste” refers to a waste from wafer slicing, which is a discarded mixture generated during a wafer slicing process. The discarded mixture may comprise particles from wire saw, filings from silicon cutting, abrasive particles such as silicon carbide, cutting fluid, or their combinations. More specifically, the wafer waste contains silicon, silicon carbide and a cutting fluid.

In the above-mentioned method, the step (A) comprises diluting the wafer waste with an amount of a second aqueous solvent to obtain a diluted wafer waste having a reduced viscosity. Here, the second aqueous solvent used for diluting the wafer waste may be any pure water, water-containing solution, or recycling water collected by other steps of the present method (e.g. a first recycling water, a second recycling water or their combinations). Preferably, the amount of the second aqueous solvent relative to the wafer waste may range from 10 percentages by weight (wt %) to 500wt %, and more preferably range from 50wt % to 200wt %. Besides, the amount of the second aqueous solvent relative to the cutting fluid of the wafer waste may range from 20wt % to 1000wt %, and more preferably range from 50wt % to 300wt %. In other words, the diluted wafer waste preferably has a viscosity ranging from 2 cP to 50 cP to maintain the efficiency of solid-liquid separation for the diluted wafer waste in the step (B) of the present method.

After obtaining the liquid mixture by the solid-liquid separation, the step (B) comprises separating the liquid mixture to obtain the first recycling water and the recovered cutting fluid by evaporation. Wherein, the first recycling water and the cutting fluid are isolated from the liquid mixture by evaporation depending on their different boiling points. Because the first recycling water can be reused and recycled in other steps of the present method, an amount of wastewater generated during the recovering process of wafer waste can be reduced.

In the step (C) of the above-mentioned method, the amount of the first aqueous solvent relative to the solid mixture may range from 100 wt % to 2000 wt %. Preferably, the amount of the first aqueous solvent relative to the solid mixture may range from 100 wt % to 1500 wt %, and more preferably range from 100 wt % to 1000 wt %.

According to the above-mentioned method in accordance with the present invention, such additive agents and suspending agents in the wafer waste are absorbed onto the particle surface of the solid mixture, such that the separation efficiency of mixing slurry by using the hydrocyclone and/or the purity of the recovered silicon and recovered silicon carbide from the wafer waste are reduced. For example, said “additive agent” may be sodium hexametaphosphate (Na₆(PO₃)₆) or ethylenediaminetetraacetic acid (EDTA), and said “suspending agent” may be triethanolamine, dodecane amine, or sodium dodecyl sulfonic acid.

In order to improve the separation efficiency of mixing slurry and the recovery ratios of the recovered silicon and the recovered silicon carbide from the wafer waste, the step (C) of the method in accordance with the present invention preferably comprises mixing the first aqueous solvent with the solid mixture to obtain a pre-mixture; solid-liquid separating the pre-mixture into a second recycling water and a washed mixture; and mixing a third aqueous solvent with the washed mixture to obtain the mixing slurry.

The step of mixing the first aqueous solvent with the solid mixture is considered a washing process, which makes the additive agents and/or suspending agents of the solid mixture re-dissolved into the pre-mixture. After separating the pre-mixture by solid-liquid separation, the additive agents and/or suspending agents are dissolved in the second recycling water, thus the amount of additive agents and/or suspending agents in the washed mixture can be reduced. Preferably, the afore-mentioned step of mixing the first aqueous solvent with the solid mixture can be repeatedly performed multiple times to completely remove the additive agents and/or suspending agents from the washed mixture.

The second recycling water collected from the afore-mentioned washing process can be reused in other steps of the present method, and thereby the amount of wastewater generated during the recovering process of the wafer waste can be largely reduced.

In other words, said “first aqueous solvent”, “second aqueous solvent”, and “third aqueous solvent” may be any pure water or water-containing solution. For example, the first recycling water and second recycling water collected from the afore-mentioned steps, or their combinations are considered.

In one embodiment of the present invention, the step (C) comprises mixing the first recycling water with the solid mixture to obtain the mixing slurry. In another embodiment of the present invention, the step (A) comprises diluting the wafer waste with an amount of second recycling water, wherein the amount of second recycling water relative to the wafer waste ranges from 10 wt % to 500 wt %, and more preferably ranges from 50 wt % to 200 wt %. In yet another embodiment of the present invention, the step (C) further comprises mixing the first recycling water with the solid mixture to obtain a pre-mixture; and separating the pre-mixture into a second recycling water and a washed mixture by solid-liquid separation; and mixing a third aqueous solvent with the washed mixture to obtain the mixing slurry.

In the step (D) of the above-mentioned method, the hydrocyclone is preferably operated under a pressure ranging from 0.10 mega Pascal (MPa) to 0.80 MPa, and more preferably ranging from 0.2 MPa to 0.4 MPa. Preferably, the operating temperature of the hydrocyclone ranges from 5° C. to 95° C., and more preferably ranges from 20° C. to 40° C.

According to the method of processing wafer waste of the present invention, most cutting fluid has been recovered in the aforementioned step (B) of the present method. Hence, the mixing slurry can be easily separated into two fractions of silicon-containing mixture and silicon carbide-containing mixture without mixing large amount of cutting fluid with the mixing slurry or increasing the operating temperature of the hydrocyclone.

Preferably, the silicon-containing mixture may have particle sizes ranging from 0.01 micrometer (μm) to 5.00 μm, and the silicon carbide-containing mixture may have particle sizes ranging from 1.00 μm to 50.00 μm.

More preferably, the step (D) comprises separating the mixing slurry into the silicon-containing mixture having a particle size ranging from 0.01 micrometer (μm) to 5.00 μm and the silicon carbide-containing mixture having a particle size ranging from 1.00 μm to 50.00 μm by using multiple hydrocyclones in parallel connection.

In the step (E) of the above-mentioned method, the acidic solution is used to wash the silicon-containing mixture in order to remove the iron components from silicon-containing mixture and in order to increase the purity of recovered silicon. Also, the acidic solution is used to wash the silicon carbide-containing mixture in order to remove the iron components from silicon carbide-containing mixture and in order to increase the purity of recovered silicon carbide. For example, the acidic solution may be nitric acid (HNO₃), sulfuric acid (H₂SO₄), or hydrochloric acid (HCl). The basic solution is used to wash the silicon carbide-containing mixture in order to remove silicon components from the silicon-containing mixture and in order to increase the purity of recovered silicon carbide. For example, the basic solution may be sodium hydroxide (NaOH) or potassium hydroxide (KOH).

Accordingly, the cutting fluid, silicon, and silicon carbide can be recovered from the wafer waste in the same process by the method of processing wafer waste in accordance with the present invention. The recovery rate of the recovered cutting fluid can be more than 90%, and preferably range from 90% to 99.5% based on the weight of the cutting fluid contained in the wafer waste of the step (A). The recovery rate of the recovered silicon ranges from 60% to 95%, and preferably ranges from 90% to 95% based on the weight of silicon contained in the wafer waste of the step (A). The recovery rate of the recovered silicon carbide can be more than 90%, and preferably range from 90% to 95% based on the weight of silicon carbide contained in the wafer waste of the step (A). The purity of the recovered silicon ranges from 60% to 95%, and the purity of the recovered silicon carbide ranges from 90% to 99.5%.

Preferably, the recovered silicon can be doped with a component selected from the group consisting of: boron, phosphorus, arsenic, antimony, aluminum, germanium, and indium.

According to the present invention, said “solid-liquid separation” comprises the method of centrifuge separation, filter-pressing separation, sedimentation, membrane filtration, or decantation separation.

According to the present invention, said “hydrocyclone” refers to an apparatus to separate the mixture into different kinds of particles by their different intrinsic characteristics such as size and density. As the mixture is fed into the inlet of the hydrocyclone and entered into the chamber, particles having different intrinsic characteristics will be drawn by different forces (e.g. centrifugal force, centripetal force, fluidic drag force) by rapid and tangential centrifuge and sedimentation in the chamber of the hydrocyclone. Large-sized particles are forced to and slipped down along the wall of the chamber, and thus being collected from an underflow outlet of the hydrocyclone. On the contrary, small-sized particles are drawn to the top of the chamber, and thus being collected from an overflow outlet of the hydrocyclone. Therefore, particles with different intrinsic characteristics can be separated into two fractions by using the hydrocyclone.

In conclusion, the method of processing wafer waste in accordance with the present invention has the following advantages of:

(1) Increasing the Total Recovery Rate:

Conventional method only can recover solid silicon and silicon carbide, or only can recover liquid cutting fluid. However, the method of the present invention can recover the cutting fluid, silicon, and silicon carbide in the same process. Thus, the total recovery rate of recovering the wafer waste can be largely increased.

(2) Increasing the Individual Recovery Rate of the Recovered Silicon and the Recovered Silicon Carbide:

Because the cutting fluid is isolated and collected from the diluted wafer waste before using the hydrocyclone to separate the mixing slurry, the individual recovery rate of the recovered silicon and the recovered silicon carbide can be increased.

(3) Lower Recovery Cost and Simpler Recovering Method than Prior Art:

There is no need to mix large amount of cutting fluid with the mixing slurry or increase the operating temperature of the hydrocyclone to carry out the isolation of silicon-containing mixture and the silicon carbide-containing mixture, thus the recovery cost and complexity of recovery process can be reduced by the method of the present invention.

(4) Reducing the Manufacture Cost:

The recovered silicon carbide can be reused as abrasive particles in the wafer cutting process, thus the manufacture cost of producing wafer can be reduced. The recovered silicon can be also reused in semiconductor field such as lithium-ion secondary battery or solar cell. In addition, the cutting fluid also can be reused in the wafer cutting process.

Furthermore, according to the method of processing wafer waste in accordance with the present invention, the additive agents and/or suspending agents of wafer waste are removed by one or more than one washing process, so that the purity of recovered silicon and recovered silicon carbide can be increased. In addition, because the first recycling water and the second recycling water can be reused in other steps of the present method, and thereby the recovery cost and amount of wastewater generated during the present method can be largely reduced.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the method of processing wafer waste in accordance with Example 1 of the present invention;

FIG. 2 is a block diagram of the method of processing wafer waste in accordance with Example 2 of the present invention; and

FIG. 3 is a schematic diagram of the connection of multiple hydrocyclones in accordance with Example 2 of the present invention.

### DETAILED DESCRIPTION OF THE PREFERRED EMBODIMENTS

Hereinafter, one skilled in the arts can easily realize the advantages and effects of the method of processing wafer waste in accordance with the present invention from the following examples. Therefore, the descriptions proposed herein are just preferable examples for the purpose of illustrations only, not intended to limit the scope of the invention. Various modifications and variations could be made in order to practice or apply the present invention without departing from the spirit and scope of the invention.

### Example 1

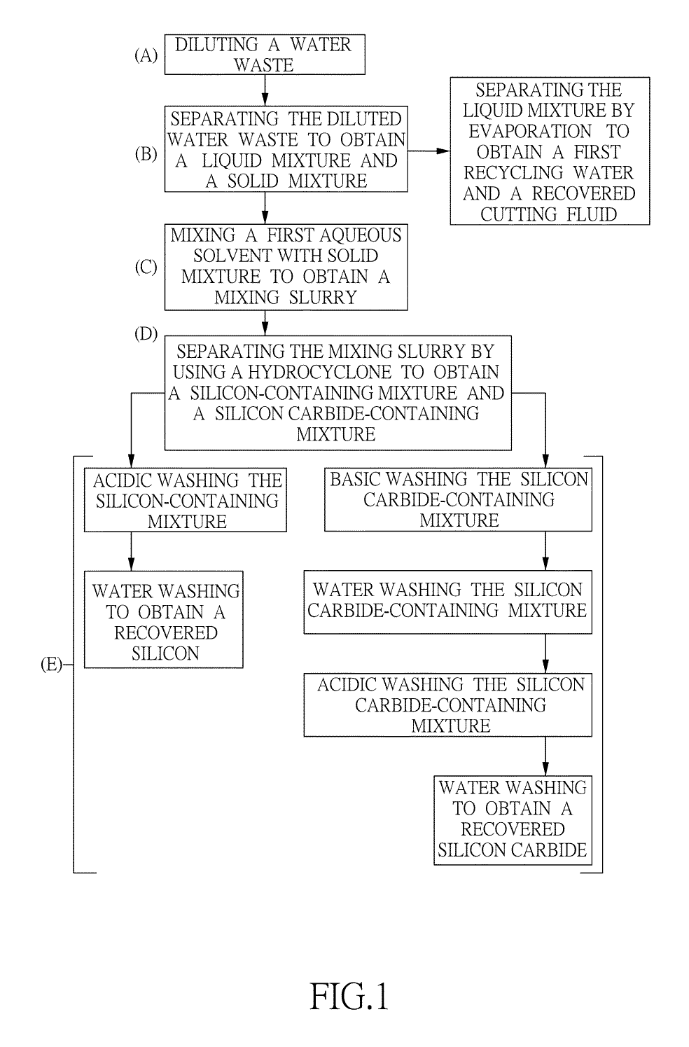

In the present example, a method of processing wafer waste is implemented as described in detail incorporating the block diagram as shown in FIG. 1.

In the step (A), a wafer waste is provided. Analysis result shows that the wafer waste comprises 500 kilograms (kg) of cutting fluid, 300 kg of silicon carbide, 190 kg of silicon, and 10 kg of iron. In this step, 5000 kg of water is mixed into the wafer waste with agitation to obtain a diluted wafer waste having a viscosity of 2 cP.

In the step (B), 6000 kg of diluted wafer waste is separated into 5286 kg of liquid mixture and 500 kg of solid mixture by solid-liquid separation, and rest 214 kg of solvent is mixed with the solid mixture. In this example, the solid-liquid separation used to preliminarily separate the diluted wafer waste is filter-pressing separation. The liquid mixture is further separated by evaporation to obtain a first recycling water and a recovered cutting fluid.

In this step, the recovered cutting fluid from the liquid mixture has a weight about 480 kg, and its recovery rate reaches about 96%. Here, the recovered cutting fluid can be reused in wafer cutting factory, so that the cost of wafer cutting process will be largely reduced.

Analysis result shows that the solid mixture obtained in step (B) comprises 300 kg of silicon carbide, 190 kg of silicon, and 10 kg of iron. In the step (C), 5000 kg of first aqueous solvent is mixed with 500 kg of solid mixture, and then a mixing slurry is obtained. Here, the amount of the first aqueous solvent relative to the solid mixture is almost 1000 wt %.

In the step (D), the mixing slurry is fed into the inlet of the hydrocyclone. The hydrocyclone separates the mixing slurry into two fractions under an operating pressure ranging from 0.10 MPa to 0.80 MPa and at an operating temperature of 25° C. After separation, the mixing slurry is separated into two fractions of particle sizes ranging from 0.01 μm to 5.00 μm (i.e. silicon-containing mixture) and of particle sizes ranging from 1.00 μm to 50.00 μm (i.e. silicon carbide-containing mixture). Then, the silicon-containing mixture and the silicon carbide-containing mixture are respectively collected at the overflow and the underflow of the hydrocyclone, and thus the silicon-containing mixture and the silicon carbide-containing mixture is preliminarily isolated by the hydrocyclone.

Analysis result shows that the silicon-containing mixture comprises 170 kg of silicon, 20 kg of silicon carbide-containing mixture, and 8 kg of iron, and the silicon carbide-containing mixture comprises 280 kg of silicon carbide, 20 kg of silicon, and 2 kg of iron.

In the step (E), the silicon-containing mixture is washed with the sulfuric acid, and then the iron contained in the silicon-containing mixture is removed. Subsequently, the acidic washed silicon-containing mixture is further washed with water to remove the undesired impurities, and finally a recovered silicon is obtained. Besides, the silicon carbide-containing mixture is washed with sodium hydroxide, and then the undesired silicon contained in the silicon carbide-containing mixture is removed. The basic washed silicon carbide-containing mixture is further washed with water in order to remove the undesired impurities. Subsequently, the washed silicon carbide-containing mixture is further washed with sulfuric acid, and then the iron contained in the silicon carbide-containing mixture is also removed. A similar washing process is performed to acidic washed silicon carbide-containing mixture to remove the undesired impurities, and finally a recovered silicon carbide is obtained.

According to the method of processing wafer waste, the results of recovery rates and purities of recovered silicon and recovered silicon carbide after acidic and/or basic washing depending on different operating pressures of the hydrocyclone are listed on Table 1.

TABLE 1
Recovery rates and purities of recovered silicon and recovered
silicon carbide depending on different operating pressures of
hydrocyclone.

| Operating | Silicon | | Silicon Carbide | |
|---|---|---|---|---|
| Pressure | Purity | Recovery rate | Purity | Recovery rate |
| 0.25 MPa | 48.31% | 85% | 90.34% | 85% |
| 0.30 MPa | 79.85% | 90% | 92.01% | 90% |
| 0.40 MPa | 95.00% | 95% | 95.00% | 95% |
| 0.50 MPa | 51.63% | 80% | 94.84% | 80% |
| 0.65 MPa | 44.18% | 75% | 95.58% | 75% |

As described by the method of processing the wafer waste in accordance with the present invention, the cutting fluid, silicon, and silicon carbide of wafer waste can be recovered in the same process. Because the recovered cutting fluid is collected and does not remain in the mixing slurry before separating the mixing slurry, the separation efficiency of mixing slurry by using the hydrocyclone will be largely increased. For same reason, the total and individual recovery rates of recovered cutting fluid, recovered silicon, and recovered silicon carbide will also be largely increased.

### Example 2

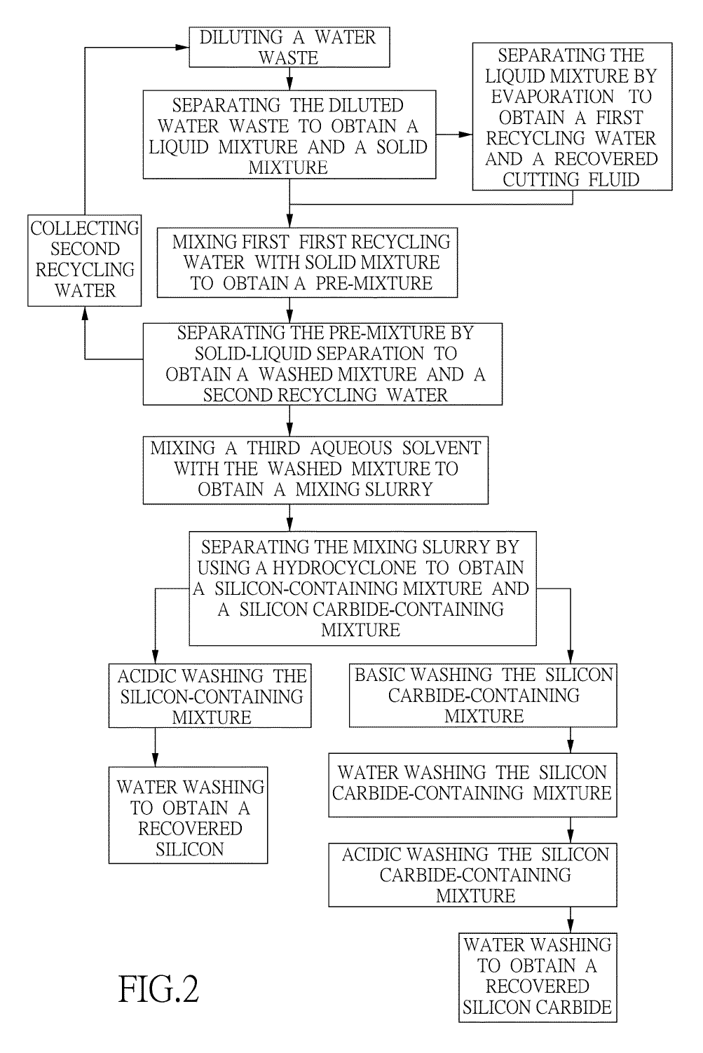

In the present example, the method of processing wafer waste is implemented as described in detail incorporating the block diagram as shown in FIG. 2. In the present example, the amount of wastewater generated during the recovering process of wafer waste is reduced by collecting and reusing the first recycling water and the second recycling water.

In the present example, a similar step (A) and step (B) are performed as in example 1. The first recycling water is collected in the step (B). Besides, a similar step (D) and step (E) are also performed as in example 1 to accomplish the process of recovering the recovered silicon and the recovered silicon carbide from wafer waste.

The differences between examples 1 and 2 are described below.

The first recycling water obtained in step (B) is reused, which replaces the first aqueous solvent to wash the solid mixture in the step (C). 5000 kg of the first recycling water is mixed with the solid mixture to form a pre-mixture. Then, the pre-mixture is further separated into 4785 kg of second recycling water and 500 kg of washed mixture by solid-liquid separation. In this example, the solid-liquid separation is filter-pressing separation. Then, 500 kg of washed mixture is mixed with 5000 kg of a third aqueous solvent again to obtain the mixing slurry. According to the present invention, the first recycling water, second recycling water, third recycling water or their combinations can be used for replacing the third aqueous solvent to mix with the washed mixture. Analysis result shows that the washed mixture comprises 300 kg of silicon carbide, 190 kg of silicon, and 10 kg of iron.

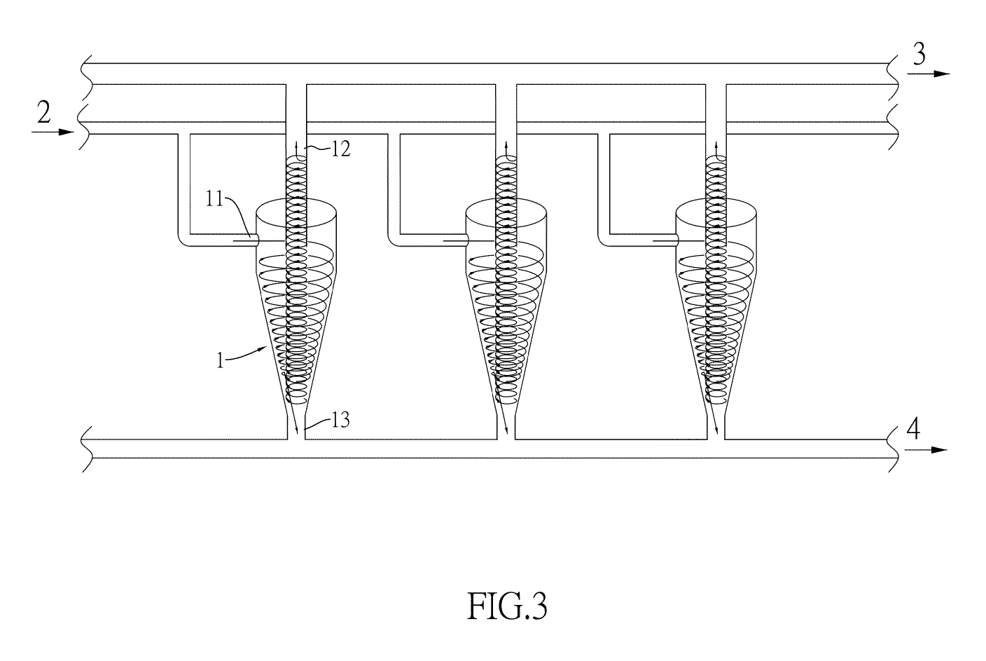

In the present example, the second aqueous solvent can be replaced by collecting second recycling water in the afore-mentioned step. The second recycling water also can be mixed with the wafer waste in the step (A) to dilute the wafer waste. As shown by FIG. 3, multiple hydrocyclones (1) are used simultaneously to increase the recovery efficiency. The afore-mentioned mixing slurry is fed into the inlet pipe (2), and then entered into the inlets of three hydrocyclones (11) in parallel connection through the inlet pipe (2). Every hydrocyclone (1) has a respective overflow outlet 12) connected with the overflow pipe (3) for conveying the silicon-containing mixture, and every hydrocyclone has a respective underflow outlet (13) connected with the underflow pipe (4) for conveying the silicon carbide-containing mixture. After separation, the silicon-containing mixtures isolated from the mixing slurry will be collected at the overflow pipe outlet, and the silicon-containing mixtures isolated from the mixing slurry will be collected at the underflow pipe outlet.

In the present example, the hydrocyclone separates the mixing slurry into two fractions under an operating pressure of 0.35 MPa at an operating temperature of 25° C. Analysis result shows that the silicon-containing mixture comprises 170 kg of silicon, 20 kg of silicon carbide-containing mixture, and 8 kg of iron, and the silicon carbide-containing mixture comprises 280 kg of silicon carbide, 20 kg of silicon, and 2 kg of iron.

In the present example, the recovery rate of recovered cutting fluid is more than 96 wt % based on the weight of the cutting fluid contained in the wafer waste. The recovery rate of recovered silicon is 89.5 wt % based on the weight of silicon contained in the wafer waste, and the purity of the recovered silicon is 89.5%. The recovery rate of recovered silicon carbide is 93 wt % based on the weight of silicon carbide contained in the wafer waste, and purity of the recovered silicon carbide is 99.5%.

The content of recovered silicon is analyzed by inductive coupled plasma atomic emission spectroscopy (ICP-AES). The result shows that the recovered silicon is doped with 0.1 wt % of boron.

Thus, the cutting fluid, silicon, and silicon carbide of wafer waste can be recovered in the same process. Because the first recovering water and the second recovering water can be reused in other steps, the recovery cost of wafer waste and the amount of wastewater generated by this process can be largely reduced.

In addition, multiple hydrocyclones in parallel connection are suitable for processing large amount of wafer waste simultaneously. Thus, the method of processing wafer waste in accordance with the present invention can increase the recovering effect and recovering rate of wafer waste, and provide a more effective method of processing the wafer waste than conventional methods.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of processing wafer waste, comprising the steps of:
(A) diluting a wafer waste to obtain a diluted wafer waste, wherein the wafer waste contains silicon, silicon carbide and a cutting fluid;
(B) separating the diluted wafer waste into a liquid mixture and a solid mixture, and separating the liquid mixture to obtain a first recycling water and a recovered cutting fluid;
(C) mixing an amount of a first aqueous solvent with the solid mixture to obtain a mixing slurry;
(D) separating the mixing slurry into a silicon-containing mixture and a silicon carbide-containing mixture by using a hydrocyclone; and
(E) washing the silicon-containing mixture with an acidic solution to obtain a recovered silicon from the washed silicon-containing mixture, and washing the silicon carbide-containing mixture with a basic solution and the acidic solution in sequence to obtain a recovered silicon carbide from the washed silicon carbide-containing mixture.

2. The method as claimed in claim 1, wherein the step (A) comprises diluting the wafer waste with an amount of a second aqueous solvent to obtain the diluted wafer waste, and the amount of the second aqueous solvent relative to the wafer waste ranges from 10 percentages by weight (wt %) to 500 wt %.

3. The method as claimed in claim 1, wherein the step (B) comprises separating the liquid mixture to obtain the first recycling water and the recovered cutting fluid by evaporation.

4. The method as claimed in claim 1, wherein the amount of the first aqueous solvent relative to the solid mixture ranges from 100 wt % to 1000 wt %.

5. The method as claimed in claim 1, wherein the step (C) comprises mixing the first aqueous solvent with the solid mixture to obtain a pre-mixture;
separating the pre-mixture into a second recycling water and a washed mixture by solid-liquid separation; and mixing a third aqueous solvent with the washed mixture to obtain the mixing slurry.

6. The method as claimed in claim 5, wherein the step (A) comprises diluting the wafer waste with an amount of the second recycling water to obtain the diluted wafer waste, and the amount of the second recycling water relative to the wafer waste ranges from 10 wt % to 500 wt %.

7. The method as claimed in claim 1, wherein the first aqueous solvent is the first recycling water, and the step (C) comprises mixing the first recycling water with the solid mixture to obtain the mixing slurry.

8. The method as claimed in claim 7, wherein the step (C) further comprises mixing the first recycling water with the solid mixture to obtain a pre-mixture; and separating the pre-mixture into a second recycling water and a washed mixture by solid-liquid separation; and mixing a third aqueous solvent with the washed mixture to obtain the mixing slurry.

9. The method as claimed in claim 1, wherein the hydrocyclone is operated under a pressure ranging from 0.10 mega Pascal (MPa) to 0.80 MPa.

10. The method as claimed in claim 1, wherein the silicon-containing mixture has particle sizes ranging from 0.01 micrometer (μm) to 5.00 μm, and the silicon carbide-containing mixture has particle sizes ranging from 1.00 μm to 50.00 μm.

11. The method as claimed in claim 1, wherein the step (D) comprises separating the mixing slurry into the silicon-containing mixture having a particle size ranging from 0.01 micrometer (μm) to 5.00 μm and the silicon carbide-containing mixture having a particle size ranging from 1.00 μm to 50.00 μm by using multiple hydrocyclones in parallel connection.

12. The method as claimed in claim 1, wherein the diluted wafer waste has a viscosity ranging from 2 centipoise (cP) to 50 cP.

13. The method as claimed in claim 1, wherein the recovery rate of the recovered cutting fluid is more than 90% based on the weight of the cutting fluid contained in the wafer waste.

14. The method as claimed in claim 1, wherein the recovery rate of the recovered silicon ranges from 60% to 95% based on the weight of silicon contained in the wafer waste.

15. The method as claimed in claim 1, wherein the purity of the recovered silicon ranges from 60% to 95%.

16. The method as claimed in claim 1, wherein the recovery rate of the recovered silicon carbide is more than 90% based on the weight of silicon carbide contained in the wafer waste.

17. The method as claimed in claim 1, wherein the purity of the recovered silicon carbide ranges from 90% to 99.5%.

18. The method as claimed in claim 1, wherein the recovered silicon is doped with a component selected from the group consisting of: boron, phosphorus, arsenic, antimony, aluminum, germanium, and indium.
